(19) United States
(12) Patent Application Publication
(10) Pub. No.: US 2019/0050912 A1
(43) Pub. Date: Feb. 14, 2019

(54) METHODS, APPARATUSES, AND COMPUTER-READABLE MEDIA FOR CONTENT CREATION AND DISTRIBUTION

(71) Applicant: GOOGLE LLC, Mountain View, CA (US)

(72) Inventors: Chao Liu, San Francisco, CA (US); Nicholas Snyder, San Mateo, CA (US); Alexander Kuscher, San Francisco, CA (US); Christopher Michael Goddard, San Francisco, CA (US); Hwi Kyoung Lee, Mountain View, CA (US)

(21) Appl. No.: 16/120,168

(22) Filed: Aug. 31, 2018

Related U.S. Application Data
(63) Continuation of application No. 13/309,027, filed on Dec. 1, 2011.
(60) Provisional application No. 61/547,616, filed on Oct. 14, 2011.

(51) Int. Cl. G06Q 30/02

(52) U.S. Cl. CPC G06Q 30/0276

(57) ABSTRACT

Providing content items on electronic documents comprises a content item server. The server identifies features associated with a particular item and receives a request to create a content item to be displayed on user computing devices. The server creates a content item comprising at least one of the features associated with the particular item. The server receives a request to display the content item in conjunction with an electronic document on a user computing device and assesses at least one updated features associated with the content item. The server updates the content item with the at least one updated feature associated with the item and provides the updated content item to the user computing device to display in conjunction with the electronic document.

### FIELD OF ENDEAVOR

Aspects of the present invention relate to methods, systems, and computer-readable media for content creation and distribution. Specifically, aspects of the present invention relate to creating content and updating particular features of the content item in real time for presentation with electronic documents.

### BACKGROUND

Content providers provide content items to be presented to users with electronic documents. The content providers often desire to create relevant content items and only provide the content items with relevant electronic documents. When the content items, the electronic documents, and the users are relevant, the viewers of the documents are more likely to be interested in the content item.

### SUMMARY

In one aspect of the present invention, the invention is directed to a method to provide content items on electronic documents. A server server identifies features associated with a particular item and receives a request to create a content item to be displayed on user computing devices. The server creates a content item comprising at least one of the features associated with the particular item. The server receives a request to display the content item in conjunction with an electronic document on a user computing device and assesses at least one updated features associated with the content item. The server updates the content item with the at least one updated feature associated with the item and provides the updated content item to the user computing device to display in conjunction with the electronic document.

Additional aspects of the present invention are directed to computer systems and to machine-readable media having features relating to the foregoing aspects.

### BRIEF DESCRIPTION OF THE DRAWINGS

The systems and methods discussed will become more fully understood from the detailed description given herein below and the accompanying drawings which are given by way of illustration only, and thus are not limitative, and wherein:

FIG. 1 is a block diagram illustrating an automatic ad campaign system, according to an embodiment.

FIG. 2 is a flow diagram illustrating an overview of the process of campaign creation, according to an embodiment.

FIG. 3 is a flow diagram illustrating details for creating an ad campaign, according to an embodiment.

FIG. 4 is a flow diagram illustrating an example process for promoting and managing applications in an ad campaign, according to another embodiment.

FIG. 5 is an illustration of an example ad creative, according to an embodiment.

FIG. 6 is a block diagram illustrating an exemplary system upon which embodiments may be implemented.

The drawings will be described in detail in the course of the detailed description.

### DETAILED DESCRIPTION

The following detailed description refers to the accompanying drawings. The same reference numbers in different drawings identify the same or similar elements. Also, the following detailed description does not limit the concepts discussed. Instead, the scope of the concepts discussed herein is defined by the appended claims and equivalents thereof.

### Introduction

In one embodiment of the present invention, a campaign server 102 provides for a one-stop, easy-to-use interface for advertisers to create content item campaigns that will help promote and monetize their goods and services. The content items may be ads, and the content item campaigns may be ad campaigns.

Users, such as advertisers, may utilize the campaign server 102 to automatically create ad campaigns for their goods and services. Campaign server 102 may automatically manage various aspects of creating and managing an ad campaign, such as generating the ad creative, determining the appropriate ad distribution parameters, determining the hardware and software platforms required of the devices that are served ads, etc.

In order to present a concrete example of automatic ad campaign creation, techniques are described in the present specification for automatically creating an ad campaign for mobile applications. However, those of ordinary skill in the art will recognize that the techniques presented in this specification are applicable to create ad campaigns for any kind of good or service.

In some embodiments, any item that is available in an electronic marketplace may be the basis for creating an ad campaign. The item may be any type of item, including electronic books, music, cars, software, or any goods or services. The item may be intangible, i.e. services or the type that may be sent over the Internet, such as software, music, or electronic books. The item may also be tangible, such as books, music, and cars. The creation of ad campaigns as described in this specification is not limited to any particular type of item.

The campaign server 102 may automatically harvest product data from online sellers of mobile applications in order to create the ad creatives and set the ad campaign parameters. The campaign server may automatically determine and populate ad campaign parameters using the harvested application data. Campaign server 102 may automatically determine the appropriate ad distribution parameters. The ad distribution parameters set the parameters for distribution of the ad. The parameters may include the country, the geography, the language, and other factors affecting how the ad is distributed.

For example, campaign server 102 may automatically determine, as an aggregate trend, which applications have been previously purchased from an electronic marketplace. Distribution parameters may be determined based on aggregate data that indicates that application X also purchased when application Y is purchased. Campaign server 102 may also automatically determine, in the aggregate, which applications are being downloaded and used, and set the distribution parameters based on such aggregate data. Even though the information being collected is aggregated and does not contain a user ID or other means for identifying particular users, individual users may also opt out of having their purchase information included in the aggregate information.

Also, certain geographic areas may also be selected for ad serving based on the languages of the product that is available for sale in the electronic marketplace. For example, if the product is available for sale in the electronic marketplace in the Spanish language, then the problem might be advertised in Mexico or other Latin American markets. Certain hardware and/or software operational requirements may also be selected as a distribution parameter. For example, if the product requires version 1.2.2 of an operating system, then the product might be advertised to devices with version 1.2.2 of the operating system installed. As another example, if the product requires a machine with a particular central processing unit (CPU), then only devices with that CPU may receive the advertisement. Other ad campaign parameters may also be set by campaign server 102 and are discussed further in the present specification

Campaign server 102 may also automatically generate and update ad creatives for the advertising campaigns. Campaign server 102 may pull ratings, price, description, icon, and other data regarding applications automatically from a source of application data. The pulled data may be used in the generation of the ad creative. Changes to the application data at the source of the harvested data may trigger campaign server 102 to automatically update the generated ad creatives.

### Structural and Functional Overview

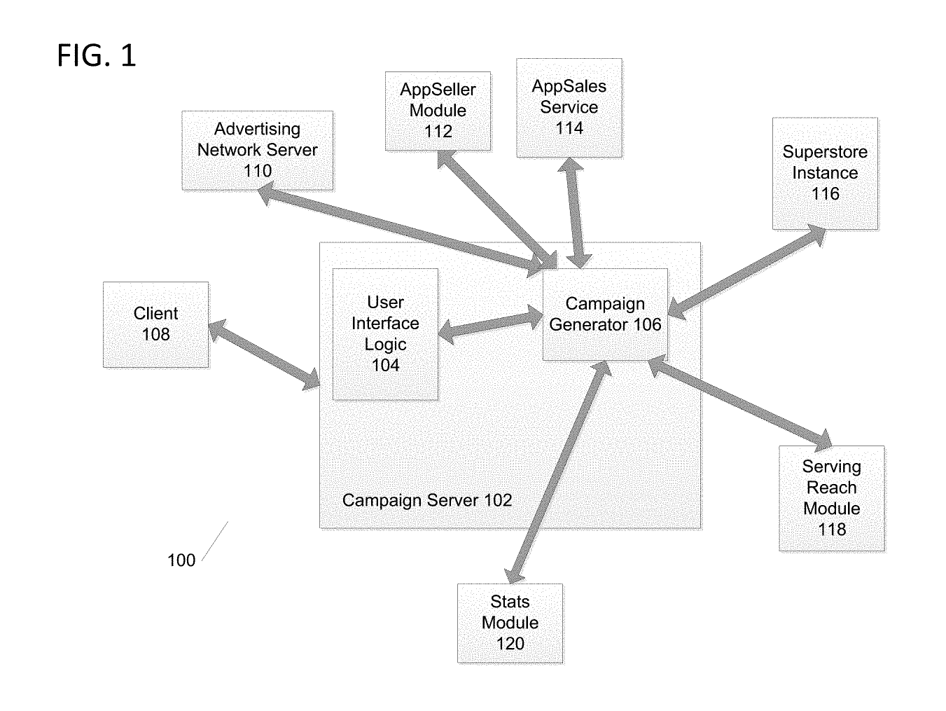

FIG. 1 is a block diagram illustrating an automatic ad campaign system 100, according to an embodiment. As illustrated in FIG. 1, the automatic ad campaign system 100 may include a campaign server 102 with user interface logic 104 and campaign generator 106. The user interface logic 104 of the campaign server 102 sends data for a user interface display to a client 108. Client 108 may be any device, including mobile devices, desktop computers, or any other computing device. Users, such as advertisers, may interact with campaign server 102 through client 108.

Campaign generator 106 may interact with any combination of advertising network server 110, AppSeller module 112, AppSales service 114, Superstore instance 116, serving reach module 118, and stats module 120 in order to automatically create ad campaigns based on harvested data.

The campaign server may obtain item data through AppSeller module 112 and/or AppSales service 114. The harvested information may also include current sales data such as prices, ratings, descriptions, icons, and other data of applications.

The harvested data may be used to define ad distribution parameters. In some embodiments, the harvested information utilized for automatically creating an ad campaign may also include aggregate application data. Users may opt out of sending their application data for determining ad distribution parameters. Data such as the type of mobile applications that are downloaded the most may be harvested to better define the most appropriate ad distribution parameters.

Item data, such as aggregated purchasing information of the applications may be obtained through an application programming interface compiled and integrated into a module such as AppSeller module 112. The data may be used for automatically creating the ad campaign. In some embodiments, the AppSeller module 112 may be an integrated part of campaign server 102 that allows campaign server 102 to access the item data from an online application seller.

In another embodiment, campaign server may also optionally access AppSales service 114 alone or in conjunction with AppSeller module 112. AppSales service 114 may be another example source providing application data that may be used for automatically creating ad campaigns. AppSales service 114 may provide a stream or feed of application data regarding the prices, ratings, descriptions, icons, language, device hardware and software requirements, and other data of applications to the campaign server 102.

In some embodiments, campaign server 102 may send a HTTP request to AppSales service 114 for product data and receive information about that product. The data received may include, for example, item name (such as application name for mobile applications), publisher name, image URLs, icon URLs, description, version, size, supported devices, genre, etc. App server 102 may utilize the data in order to generate ad creatives for the ad campaign. In some embodiments, AppSales service 114 may also provide aggregated purchasing information.

Advertising network server 110 may be a server managing a network that distributes ads to websites and applications, and may allow developers to monetize their mobile applications and websites by displaying paid ads within the applications and websites.

The campaign server 102 may also utilize stats module 120 to retrieve statistics. In one embodiment, a data retrieval interface may be used by the campaign server 102 to retrieve ad campaign statistics from stats module 120. The statistical information may include, for example, an aggregate number of impressions and an aggregate number of click-throughs. In one embodiment, an extractor module (not depicted) that is part of stats module 120 may be responsible for extracting aggregate data from impression and click logs, and storing the data in a statistics table. The campaign server 102 may use the data retrieval interface to query data from the statistics table to communicate statistical information to the client.

In some embodiments, the data retrieval interface may allow for queries by ad ID, by application ID, by publisher ID, etc. The statistical information reflects counts of impressions and click-throughs in the aggregate, and do not reflect such data for individual users. In addition, users may opt out of participating in the collection of aggregate statistics such as the impressions and click-throughs.

In some embodiments, stats module 120 may access impression logs and click logs, and process the logs according to different schedules. Impression logs may be stored with a server that serves advertisements. Since click logs may be stored on a different server, such as an advertising server that tracks click-throughs, there may be a time delay between processing impression logs and click logs. In one embodiment, the extractors may be set to avoid processing any log entries with timestamps within a threshold number of hours in order to minimize artificial fluctuations in statistics reported to users. For example, by delaying the processing of log entries, the computed click-through rate may be a more accurate representation of the ratio of impressions to clicks.

In some embodiments, a serving reach module 118 estimates an approximate number of impressions that will be served for an ad. The computation for the estimate may be based on the desired ad serving user characteristics, the hardware and software requirements of devices that will be served ads, and other criteria for selecting users and their devices for serving ads. In some embodiments, serving reach module 118 also suggests ways to improve the serving of ads that are more appropriate and interesting to users. For example, based on analysis of the harvested data, serving reach module 118 may determine that a certain age group favors strategy games, and suggest to an advertiser that such an age group be utilized as ad distribution parameters for strategy games.

In some embodiments, Superstore instance 116 stores data regarding, ads and ad groups, and other information. Campaign server 102 may store and access ads from Superstore instance 116. The ads stored in Superstore instance 16 may be used in creating ad campaigns and sent to an ads server for serving to users.

### Overview of Campaign Creation Process

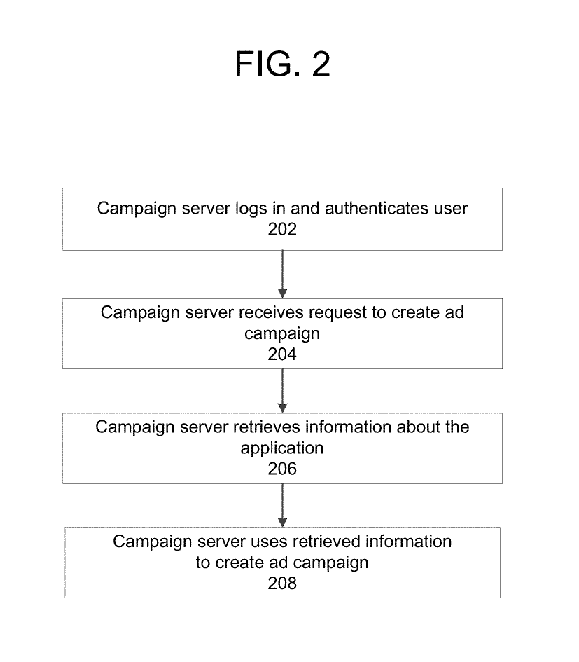

FIG. 2 is a flow diagram illustrating an overview of the process of campaign creation, according to an embodiment. In step 202, campaign server 102 logs in and authenticates user. The user may login with a social networking ID. In some embodiments, the campaign server 102 may have an interface through a website. In one embodiment, to promote mobile applications, the user may conveniently log into the campaign server 102 through menu options such as “Campaigns” and then “App Promotion” through the advertising network server 110. Yet other methods of logging and authenticating the user into the campaign server 102 are possible and embodiments of the invention are not limited to the disclosed methods.

In step 204, campaign server 102 receives a request to create an ad campaign. The request may come from the user operating the client. For example, the user may be a mobile application developer that wishes to market an application.

In step 206, campaign server 102 retrieves information about the application. In one embodiment, campaign server 102 may subscribe to a feed through AppSales service 114 in order to obtain information about the application. For example, campaign server 102 may send a request for application data to AppSales service 114 and receive information regarding the application, as described in the present specification. In another embodiment, campaign server 102 may utilize AppSeller module 112 in order to obtain information regarding the application, as described in the present specification.

In step 208, campaign server 102 uses the retrieved information to create the ad campaign. For example, campaign server 102 may use information about the application in order to determine the language, the desired characteristics of users that are served ads, the required hardware and software platforms, internationalization and localization adaptations, and other parameters for building an ad campaign. Each of the ad campaign creation parameters are discussed in detail elsewhere in the present specification.

### Details of Creating an Ad Campaign

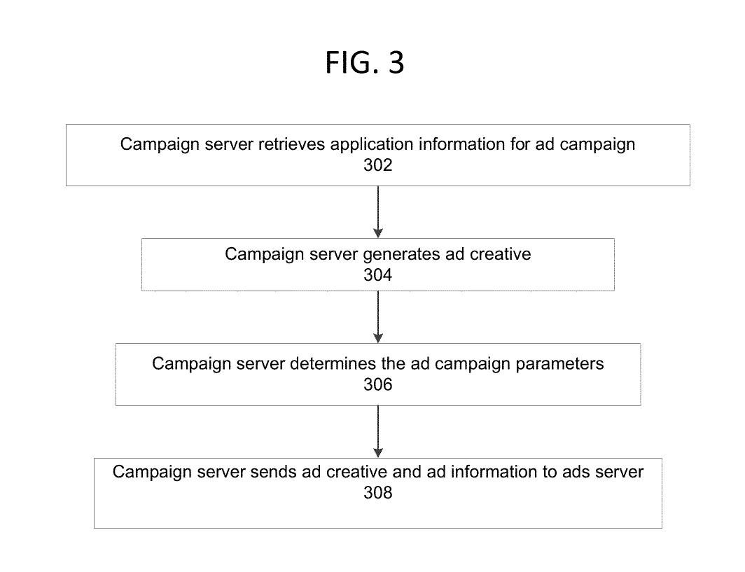

FIG. 3 is a flow diagram illustrating details for creating an ad campaign, according to an embodiment. The steps of FIG. 3 may be performed by campaign server 102.

In step 302, campaign server 102 retrieves application information for creating the ad campaign. Data may be retrieved from the AppSales service 114 and/or AppSales service 114, and/or other applications or websites that operate as electronic marketplaces, in order to create the ad campaign. In one embodiment, the campaign server 102 sends an application ID to an AppSales service 114, and receives a stream or feed of data through AppSales service 114 for the application. AppSales service 114 may be a streaming service that communicates with an online store where users can download and purchase applications. Data such as the names, icons, prices of applications, and other data regarding applications may be obtained from AppSales service 114 through the data feed. Such data may be used for automatically creating the ad campaigns.

In some embodiments, the campaign server 102 obtains application information including ratings, descriptions, icons, and other data for applications through an application programming interface compiled into a module, such as AppSeller module 112. Different embodiments may use various combinations of AppSeller module 112 and/or a feed through AppSales service 114 in order to obtain data regarding applications. Campaign server 102 may also retrieve data from an application developer's homepage or a company webpage in order to build ads.

In step 304, campaign server 102 generates the ad creative. In some embodiments, an ad can be created without a prior ad campaign setup or even without user registration. A user may create an ad first, and view preliminary results prior to starting the automatic ad campaign process. In some embodiments, ad creation may be integrated into the AppSales service 114 or a web browser. Users may operate a control on the module or browser in order to automatically create an ad and view the ad. To generate the ad creative, campaign server 102 obtains data regarding the application.

Campaign server 102 may obtain, from any online source of applications, data such as an icon, the name of the company, the price, and other data, to produce an ad message such as “Download the Math app”. The ratings and reviews of the application, title, category, and an additional description may also be retrieved. The ad may be automatically designed specifically for the application. The ratings, price, name of company, icon, data for writing the ad message, and the description may all be retrieved through, for example, AppSeller module 112 or AppSales service 114. The ratings may be, for example, ratings provided by customers of the electronic marketplace or other users who have used the application and provided ratings based on their experience with the application. The reviews may also be descriptions of experiences with the application written by customers or other users. The ratings and reviews may be stored in the electronic marketplace and retrieved from the electronic marketplace for producing the ad creative. The ratings, reviews, and other retrieved data may be displayed with or on top of the ad creative. The ad creative may also include any other information retrieved through an API or feed or some other method from an electronic marketplace.

In some embodiments, the ad creative may be updated on a regular schedule in order to show up-to-date ads. The ads may be updated automatically without requiring any action from advertisers. The ads may contain free form text fields where advertisers can provide a customized message. Some of the data displayed on the ad creative that may be updated automatically include the ratings, reviews, price, and other data retrieved from sources of application data. The data for the automatic updates may be obtained by, for example, crawling webpages with descriptions of the application, or by subscribing to a feed of information from AppSales service 114, or using AppSeller module 112.

In step 306, campaign server 102 determines the ad campaign parameters. In one embodiment, the campaign carrier chooses the default settings for the ad campaign parameters. Some of the default settings include device characteristics such as the appropriate hardware platforms, operating systems versions, and installed applications. Other default settings for the ad campaign parameters include application categories, and the countries and regions where the ad will be displayed. Some of the default settings may be determined based on data retrieved from the AppSales service 114. For example, information regarding the devices and operating system versions upon which the application will run on may be obtained from the AppSales service 114. For example, the determination of the countries and regions may be derived from the languages in which the application is available in the AppSales service 114. The campaign server 102 may also determine the language in which to display the ads by examining language data from the AppSales service 114.

The campaign server 102 may also set the default settings for geographical locations where ads will be served. By examining the geographic locations where the application is currently available through the AppSales service 114 module, the server may select similar geographic locations for the advertising.

Further, campaign server may also determine that users in certain geographical regions tend to use more applications. For example, users in Silicon Valley may tend to use more mobile applications related to learning about computers, and campaign server may serve a greater percentage of ads for such applications to Silicon Valley users.

In one embodiment, the campaign server 102 may also choose default settings for the type of applications that the ads are displayed with. For example, the campaign server 102 may serve ads to a device only when the ads are displayed on paid applications. Campaign server 102 may also serve ads to a device only when the ads are displayed on free applications. Users that have paid for applications in the past may be more likely to purchase another application. The cost (free or otherwise) of the application may be determined from the AppSales service 114. The campaign server 102 may serve ads only on applications with less than a predetermined number of users. The number of users may be determined by examining download statistics from the AppSales service 114. The application developer may also change the default settings as desired.

In one embodiment, the campaign server may also allow for automatic ad campaign creation based on buying patterns of aggregated users. Aggregated download history and buying pattern information may be mined from information stored with the AppSales service

Users may choose to opt out of allowing their device's past purchase information to be used for collecting this aggregated information. Other additional application purchase history information may also be mined from the AppSales service 114. For example, aggregated buying pattern information may show that people who liked product X also tend to like product Y and this buying pattern information may be used to define distribution parameters.

In one embodiment, the campaign server 102 may compute an estimate of the number of users that may view the ad. The computation may be based on an analysis of statistical data such as the number of qualifying devices, the number of devices in certain regions or countries, the number of users, and other aggregated statistical data regarding users and devices. The campaign server 102 may also compute the number of expected users or impressions served for the lifetime of the ad campaign.

In one embodiment, campaign server 102 may also include an ad planning module (not depicted) that plans for serving ads based on geographical data. For example, if the advertisements are served with a popular game, and most purchasers of the game are located in Mexico, then the ad planning module may favor Mexico for serving the ads, and the ads may be mostly served in Mexico. Thus, ad distribution parameters based on geography and other factors may be computed using a specialized ad planning module.

In some embodiments, campaign server 102 performs localization adaptations. Campaign server 102 may adapt the ads for the particular locality in which the ad will be served. Ad viewers in each locality may see the ad creative displayed according to their local customs. Campaign server 102 may make changes for local adaptations such as text translation, data formatting, number/currency formatting, and bi-directional text display. Campaign server 102 may determine that most of the purchases are from a particular country and adapt the ad creative for that country. Campaign server 102 may then include the country in the ad campaign.

Different countries may have different currencies and different number formatting conventions. For example, in Asia, a date may be written in day/month/year format. However, in Western countries, the date may be written in month/day/year format. The campaign server automatically manages the different formats of dates, tailoring the forming of the dates to the particular locality. The price of the application as depicted in the produced ad creative may be automatically converted to a different currency. The ad viewer may see the price of the application with the advertising according to their local currency. The currency symbol may also be replaced in the ad creative. For example, the symbol for the Japanese currency may replace the symbol for the dollar when the ad creative is shown in in Japan. In some countries, the text may be written from left to right (e.g. English), or from top to bottom (e.g. Japanese or Chinese). The campaign server may also manage the advertisements that the text is written in according to the customs of the locality in which the advertisement is served. Some languages, such as Chinese, may also be bi-directional, and can be written from left to right or right to left. Campaign server may also manage the display of text in the advertisements served to localities that use such languages.

Since the advertisements may be served to many different countries, and to different users that use different languages, an interface may be provided for advertisers to optionally define translatable messages. The messages may be translated for the different languages in which ads may be presented. For example, the advertising text may be translated to Spanish in order to display the ad to ad viewers in Spanish. The reviews shown in the ad creative may be translated to Spanish in order to display the ad creative in Spanish.

In some embodiments, the campaign server 102 may choose which wireless carriers are favored for serving ads. The campaign server 102 may analyze the aggregate data that is harvested. The aggregate data may show that users of certain wireless carriers tend to buy more of the application, or tend to buy more applications of a similar type. For example, the aggregate data may show that users of a particular carrier choose to buy driving navigation applications, and so the users of that particular carrier may be more likely to be served applications relating to driving navigation. The aggregate data may also show that users of a particular carrier tend to purchase more applications, and those such users are also more likely to be served advertisements.

In some embodiments, campaign server 102 may retrieve payment information from an online application seller. For example, credit card information may be retrieved from AppSales service 114 or through AppSeller module 112. Payment for the advertising may then be automatically completed through the retrieved payment information.

In step 308, campaign server 102 sends ad creative and ad information to ads server. The ad information may include ad serving requirements, such as serving the ad only to devices that have a particular operating system or hardware, as discussed above. The ads server may then use the data for the ad, ad serving requirements, and the ad creative in order to serve the ads to the appropriate ad viewers.

### Additional Embodiment for Promoting and Managing Applications

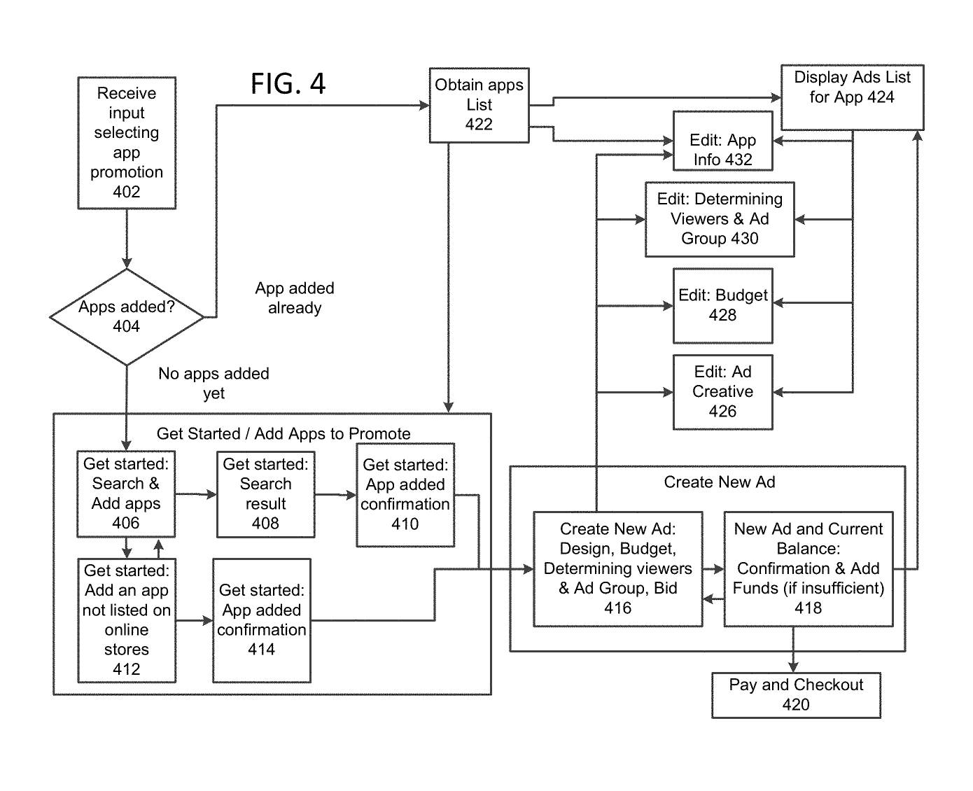

FIG. 4 is a flow diagram illustrating an example process for promoting and managing applications in an ad campaign, according to another embodiment. Those of ordinary skill in the art may recognize that the techniques illustrated in FIG. 4 may also be used to promote and manage any item in an ad campaign. In step 402, campaign server 102 receives input indicating that a user has selected a menu option or operated a control to start promoting an application. An advertising promotion of the application may include automatically creating the ad campaign. In step 404, campaign server 102 determines whether there has been at least one application added to a list of promoted applications.

If no applications had been added yet, then the user has the option of being guided through a process for adding applications to the ad campaign. This process may be automated, or the user may choose to manually perform the steps. In step 406, users may search for and add applications. The list of applications may be retrieved from a database, or obtained through AppSales service 114 or AppSeller module 112. After obtaining the search results in step 408, the user may add the application to the list of applications that are promoted. In step 410, the user receives confirmation that the applications are added.

In step 412, the user may also add an application that is not listed in an electronic marketplace. The user may provide a URL that points to a price, icon, description, and other data for the application, and the application is added to a list of applications for automatic ad campaigns and the user receives confirmation in step 414.

In step 416, one or more new ads are created. Campaign server 102 may automatically perform computations to come up with the design, budget, ad distribution parameters, desired ad viewer characteristics for serving the ads and I or platforms, operating systems, etc. Campaign server 102 may also determine the ad group and the bid price for the newly created ad, and other factors associated with promoting the newly created ad. The user may optionally choose to modify the automatically created ad promotion parameters, such as the ad creative 418, budget 422, user characteristics for serving ads and placement of ad within an ad group 420, or other ad information 424. Ad groups may be used to organize ads, and ad serving options may be customized for each ad group.

In step 418, the user may receive confirmation that the newly created ad is ready for rollout, and is added to the list of promoted ads. The user may then pay the funds that are necessary to promote the ads, as shown in step 420. The funds may also be automatically deducted from the user's funding account, such as a credit card or bank account. The campaign server 102 then forwards the completed ad campaign to the mobile advertising network in order to promote the applications.

If the user already has added applications that are being promoted, then in step 422, the campaign server 102 may obtain a list of applications that the user has promoted. Based on the list of applications, the user may edit various advertising parameters for one or more ad campaigns of various applications.

In step 424, the campaign server may optionally display a list of ads for a selected app, and allow the user to edit the ad campaign parameters for the selected app. In some embodiments, the user may edit the ad creative in step 426, the budget in step 428, the parameters or process for determining the ad distribution parameters, including ad viewer characteristics, that are the best match for serving ads with the ad group in step 430, and other application information in step 432.

In one aspect of the present invention, the invention may include a method performed by a data processing apparatus, including: receiving a request to generate an advertising campaign for an item, the request including an item ID; retrieving item information related to the item by accessing, according to the item ID, a database of items offered for sale in an electronic marketplace, wherein the retrieved item information includes information describing the characteristics of the item; and generating an ad campaign based on the retrieved information, the ad campaign incorporating campaign parameters derived from the item description information retrieved from the electronic marketplace.

In a further aspect of the invention, the method includes associating an ad creative stored in the database with the ad campaign; and modifying the ad creative based on the retrieved information.

In a further aspect of the invention, the method includes the campaign parameters includes ad distribution parameters determined from characteristics of client devices.

In a further aspect of the invention, the method includes wherein the campaign parameters includes ad distribution parameters determined from downloads of applications.

In a further aspect of the invention, the method includes wherein the retrieved information includes a description of the item.

In a further aspect of the invention, the method includes wherein the retrieved information includes purchasing data of the item.

In a further aspect of the invention, the method includes wherein the retrieved information includes reviews of the item.

In a further aspect of the invention, the method includes wherein the retrieved information includes ratings of the item.

In a further aspect of the invention, the method includes wherein the retrieved item information includes one or more supported devices.

In a further aspect of the invention, the method includes determining a distribution area of the ad campaign; and wherein the modifying the ad creative includes translating a text of the ad creative based on the distribution area of the ad campaign.

In a further aspect of the invention, the method includes determining a distribution area of the ad campaign; and wherein the modifying the ad creative includes formatting a date displayed on the ad creative based on the distribution area of the ad campaign.

In a further aspect of the invention, the method includes determining a distribution area of the ad campaign; and wherein the modifying the ad creative includes selecting and/or formatting a currency based on the distribution area of the ad campaign.

In a further aspect of the invention, the method includes wherein the associating step includes inputting a user's selection of an ad creative.

In a further aspect of the invention, the method includes wherein the retrieved information includes an item name.

In a further aspect of the invention, the method includes wherein the retrieved information includes a publisher name.

In a further aspect of the invention, the method includes wherein the retrieved information includes a URL.

In a further aspect of the invention, the method includes estimating a number of impressions based on the ad distribution parameters.

In a further aspect of the invention, the method includes reporting on a number of click-throughs for the generated advertising campaign, based on the ad distribution parameters. In a further aspect of the invention, the method includes wherein the campaign parameters include a geographic area determined based on a language used by the item.

In a further aspect of the invention, the method includes the ad campaign parameters are adapted based on a number of impressions and a number of click-throughs.

In a further aspect of the invention, the method includes the item is executable on a client device.

In a further aspect of the invention, the method includes the item information includes information about the client device.

In a further aspect of the invention, the method includes generating an ad campaign includes generating an ad campaign for an application, and the client device is a mobile device. In a further aspect of the invention, the method includes wherein changes to said item information at a source of item information data may trigger automatic updating of the ad creative.

In another aspect of the present invention, the invention may include a computer-readable medium coupled to one or more processors having instructions stored thereon that, when executed by the one or more processors, causes the one or more processors to perform operations including receiving a request to generate an advertising campaign for an item, the request including an item ID; retrieving item information related to the item by accessing, according to the item ID, a database of items offered for sale in an electronic marketplace, wherein the retrieved item information includes information describing the characteristics of the item; and generating an ad campaign based on the retrieved information, the ad campaign incorporating campaign parameters derived from the item description information retrieved from the electronic marketplace.

In a further aspect of the invention, the computer-readable medium includes additional instructions stored thereon that, when executed by the one or more processors, causes the one or more processors to perform additional operations including associating an ad creative stored in the database with the ad campaign; and modifying the ad creative based on the retrieved information.

In a further aspect of the invention, the computer-readable medium includes wherein the campaign parameters includes ad distribution parameters determined from characteristics of client devices.

In a further aspect of the invention, the computer-readable medium includes wherein the campaign parameters includes ad distribution parameters determined from downloads of applications.

In a further aspect of the invention, the computer-readable medium includes wherein the retrieved information includes a description of the item.

In a further aspect of the invention, the computer-readable medium includes wherein the retrieved information includes purchasing data of the item.

In a further aspect of the invention, the computer-readable medium includes wherein the retrieved information includes reviews of the item.

In a further aspect of the invention, the computer-readable medium includes wherein the retrieved information includes ratings of the item.

In a further aspect of the invention, the computer-readable medium includes wherein the retrieved item information includes one or more supported devices.

In a further aspect of the invention, the computer-readable medium includes additional instructions stored thereon that, when executed by the one or more processors, causes the one or more processors to perform additional operations including determining a distribution area of the ad campaign; and wherein the modifying the ad creative includes translating a text of the ad creative based on the distribution area of the ad campaign.

In a further aspect of the invention, the computer-readable medium includes additional instructions stored thereon that, when executed by the one or more processors, causes the one or more processors to perform additional operations including determining a distribution area of the ad campaign; and wherein the modifying the ad creative includes formatting a date displayed on the ad creative based on the distribution area of the ad campaign.

In a further aspect of the invention, the computer-readable medium includes additional instructions stored thereon that, when executed by the one or more processors, causes the one or more processors to perform additional operations including determining a distribution area of the ad campaign; and wherein the modifying the ad creative includes selecting and/or formatting a currency based on the distribution area of the ad campaign.

In a further aspect of the invention, the computer-readable medium includes wherein the associating step includes inputting a user's selection of an ad creative.

In a further aspect of the invention, the computer-readable medium includes wherein the retrieved information includes an item name.

In a further aspect of the invention, the computer-readable medium includes wherein the retrieved information includes a publisher name.

In a further aspect of the invention, the computer-readable medium includes wherein the retrieved information includes a URL.

In a further aspect of the invention, the computer-readable medium includes additional instructions stored thereon that, when executed by the one or more processors, causes the one or more processors to perform additional operations including estimating a number of impressions based on the ad distribution parameters.

In a further aspect of the invention, the computer-readable medium includes additional instructions stored thereon that, when executed by the one or more processors, causes the one or more processors to perform additional operations including reporting on a number of click-throughs for the generated advertising campaign, based on the ad distribution parameters.

In a further aspect of the invention, the computer-readable medium includes wherein the campaign parameters include a geographic area determined based on a language used by the item.

In a further aspect of the invention, the computer-readable medium includes wherein the ad campaign parameters are adapted based on a number of impressions and a number of click-throughs.

In a further aspect of the invention, the computer-readable medium includes wherein the item is executable on a client device.

In a further aspect of the invention, the computer-readable medium includes wherein the item information includes information about the client device.

In a further aspect of the invention, the computer-readable medium includes wherein generating an ad campaign includes generating an ad campaign for an application, and the client device is a mobile device.

In a further aspect of the invention, the computer-readable medium includes wherein changes to said item information at a source of item information data may trigger automatic updating of the ad creative.

In another aspect of the present invention, the invention may include an apparatus, including one or more processors, a computer-readable medium coupled to the one or more processors having instructions stored thereon that, when executed by the one or more processors, cause the one or more processors to perform operations including receiving a request to generate an advertising campaign for an item, the request including an item ID; retrieving item information related to the item by accessing, according to the item ID, a database of items offered for sale in an electronic marketplace, wherein the retrieved item information includes information describing the characteristics of the item; and generating an ad campaign based on the retrieved information, the ad campaign incorporating campaign parameters derived from the item description information retrieved from the electronic marketplace.

Further scope of applicability of the methods, apparatuses, and computer-readable storage mediums discussed will become apparent from the detailed description given hereinafter. However, it should be understood that the detailed description and specific examples, while indicating embodiments, are given by way of illustration only, since various changes and modifications within the spirit and scope of the concepts disclosed herein will become apparent to those skilled in the art from this detailed description.

### Example Ad Creatives

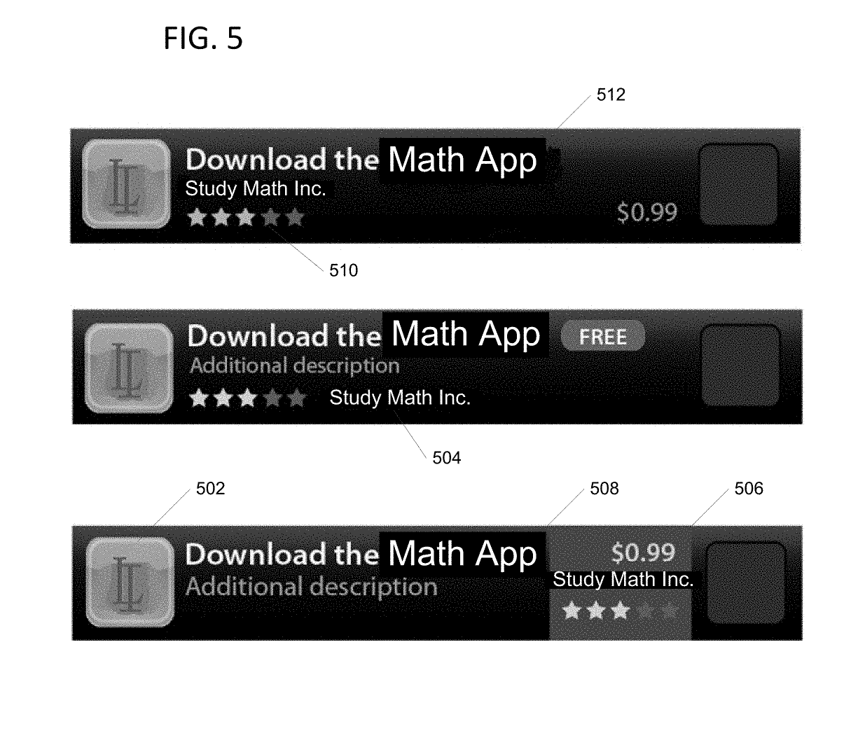

FIG. 5 is an illustration of some example ad creatives, according to an embodiment. The example ad creatives may include an icon 502, the name of the company 504, the price 506, and an ad message 508 such as “Download the Math app”. The rating of the application 510 and an additional description 512 may also be included. The ad may be automatically designed specifically for the item or application. The rating, price, name of company, icon, data for writing the ad message, and the description may all be retrieved through, for example, AppSeller module 112 or AppSales service 114. The ad creative may also include any other information retrieved through an API or feed or some other method from electronic marketplaces.

### Example Embodiments

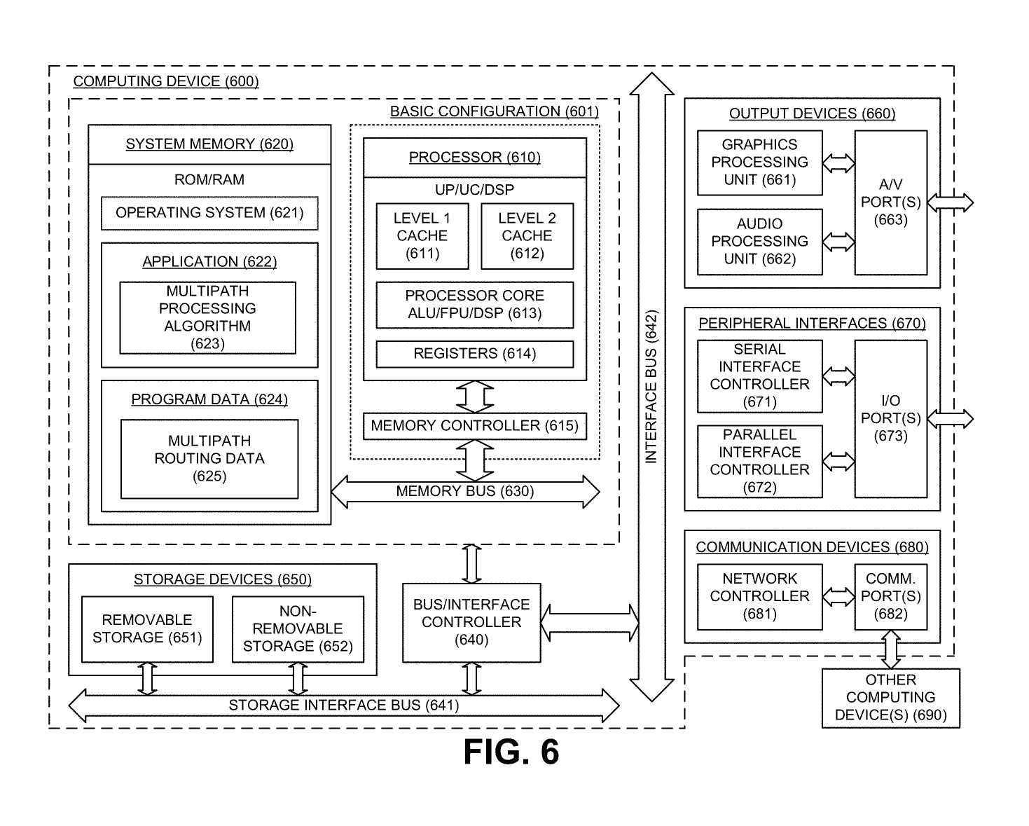

FIG. 6 is a block diagram illustrating another exemplary system 600 upon which embodiments may be implemented. For example, campaign server 102, advertising network server 110, Appinfo Module, stats module 120, client, and serving reach module 118 may be implemented with system 600. Other modules and servers may also be implemented using the exemplary system of FIG. 6, and embodiments of the invention are not limited to the listed examples. In a very basic configuration 601, computing device 600 typically includes one or more processors 610 and system memory 620. A memory bus 630 can be used for communicating between the processor 610 and the system memory 620.

Depending on the desired configuration, processor 610 can be of any type including but not limited to a microprocessor (μP), a microcontroller (μC), a digital signal processor (DSP), or any combination thereof. Processor 610 can include one more levels of caching, such as a level one cache 611 and a level two cache 612, a processor core 613, and registers 614. The processor core 613 can include an arithmetic logic unit (ALU), a floating point unit (FPU), a digital signal processing core (DSP Core), or any combination thereof. A memory controller 615 can also be used with the processor 610, or in some implementations the memory controller 615 can be an internal part of the processor 610.

Depending on the desired configuration, the system memory 620 can be of any type including but not limited to volatile memory (such as RAM), non-volatile memory (such as ROM, flash memory, etc.) or any combination thereof. System memory 620 typically includes an operating system 621, one or more applications 622, and program data 624. In some embodiments, application 622 can be arranged to operate with program data 624 on an operating system 621. This described basic configuration is illustrated in FIG. 6 by those components within dashed line 601.

Computing device 600 can have additional features or functionality, and additional interfaces to facilitate communications between the basic configuration 601 and any required devices and interfaces. For example, a bus/interface controller 640 can be used to facilitate communications between the basic configuration 601 and one or more data storage devices 650 via a storage interface bus 641. The data storage devices 650 can be removable storage devices 651, non-removable storage devices 652, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data.

System memory 620, removable storage 651 and non-removable storage 652 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media can be part of device 600.

Computing device 600 can also include an interface bus 642 for facilitating communication from various interface devices (e.g., output interfaces, peripheral interfaces, and communication interfaces) to the basic configuration 601 via the bus/interface controller 640. Example output devices 660 include a graphics processing unit 661 and an audio processing unit 662, which can be configured to communicate to various external devices such as a display or speakers via one or more AN ports 663. Example peripheral interfaces 670 include a serial interface controller 671 or a parallel interface controller 672, which can be configured to communicate with external devices such as input devices (e.g., keyboard, mouse, pen, voice input device, touch input device, etc.) or other peripheral devices (e.g., printer, scanner, etc.) via one or more I/O ports 673. An example communication device 680 includes a network controller 681, which can be arranged to facilitate communications with one or more other computing devices 690 over a network communication via one or more communication ports 682. The communication connection is one example of a communication media. Communication media may typically be embodied by computer readable instructions, data structures, program modules, or other data in a modulated data signal, such as a carrier wave or other transport mechanism, and includes any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media. The term computer readable media as used herein can include both storage media and communication media.

Computing device 600 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 600 can also be implemented as a personal computer including both laptop computer and non-laptop computer configurations.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Exemplary embodiments are shown and described in the present disclosure. It is to be understood that the embodiments are capable of use in various other combinations and environments and are capable of changes or modifications within the scope of the inventive concept as expressed herein. Some such variations may include using programs stored on non-transitory computer-readable media to enable computers and I or computer systems to carry our part or all of the method variations discussed above. Such variations are not to be regarded as departure from the spirit and scope of the invention, and all such modifications as would be obvious to one skilled in the art are intended to be included within the scope of the following claims.

What is claimed is:

1. A computer-implemented method to provide content items on electronic documents, comprising:
identifying, by one or more computing devices, features associated with a particular item;
receiving, by the one or more computing devices, a request to create a content item to be displayed on user computing devices;
creating, by the one or more computing devices, a content item comprising at least one of the features associated with the particular item;
receiving, by one or more computing devices, a request to display the content item in conjunction with an electronic document on a user computing device;
accessing, by one or more computing devices, at least one updated features associated with the content item;
updating, by the one or more computing devices, the content item with the at least one updated feature associated with the item; and
providing, by the one or more computing devices, the updated content item to the user computing device to display in conjunction with the electronic document.

2. The computer-implemented method of claim 1, wherein the identifying of the features of the particular item is based on an analysis of data associated with the particular item.

3. The computer-implemented method of claim 1, wherein the identifying of the features of the particular item is based on an input of features.

4. The computer-implemented method of claim 1, wherein the updated data is based on reviews of the particular item.

5. The computer-implemented method of claim 1, wherein the updated data is based on a current price of the particular item.

6. The computer-implemented method of claim 1, wherein the electronic document is a website.

7. The computer-implemented method of claim 1, wherein the features of the particular item are associated with one or more keywords.

8. A computer program product, comprising:
a non-transitory computer-readable storage device having computer-executable program instructions embodied thereon that when executed by a computer cause the computer to provide content items on electronic documents, the computer-executable program instructions comprising:
computer-executable program instructions to identify features associated with a particular item;
computer-executable program instructions to receive a request to create a content item to be displayed on user computing devices;
computer-executable program instructions to create a content item comprising at least one of the features associated with the particular item;
computer-executable program instructions to receive a request to display the content item in conjunction with an electronic document on a user computing device;
computer-executable program instructions to assess at least one updated features associated with the content item;
computer-executable program instructions to update the content item with the at least one updated feature associated with the item; and
computer-executable program instructions to provide the updated content item to the user computing device to display in conjunction with the electronic document.

9. The computer program product of claim 8, wherein the identifying of the features of the particular item is based on an analysis of data associated with the particular item.

10. The computer program product of claim 8, wherein the identifying of the features of the particular item is based on an input of features.

11. The computer program product of claim 8, wherein the updated data is based on reviews of the particular item.

12. The computer program product of claim 8, wherein the updated data is based on a current price of the particular item.

13. The computer program product of claim 8, wherein the electronic document is a web site.

14. The computer program product of claim 8, wherein the features of the particular item are associated with one or more keywords.

15. A system to provide content items on electronic documents, comprising:
a storage device; and
a processor communicatively coupled to the storage device, wherein the processor executes application code instructions that are stored in the storage device to cause the system to:
identify features associated with a particular item;
receive a request to create a content item to be displayed on user computing devices;
create a content item comprising at least one of the features associated with the particular item;
receive a request to display the content item in conjunction with an electronic document on a user computing device;
assess at least one updated features associated with the content item;
update the content item with the at least one updated feature associated with the item; and
provide the updated content item to the user computing device to display in conjunction with the electronic document.

16. The system of claim 15, wherein the identifying of the features of the particular item is based on an analysis of data associated with the particular item.

17. The system of claim 15, wherein the identifying of the features of the particular item is based on an input of features.

18. The system of claim 15, wherein the updated data is based on reviews of the particular item.

19. The system of claim 15, wherein the updated data is based on a current price of the particular item.

20. The system of claim 15, wherein the electronic document is a website.
